(19) United States
(12) Patent Application Publication
(10) Pub. No.: US 2015/0253584 A1
(43) Pub. Date: Sep. 10, 2015

(54) EYEGLASS RETAINMENT DEVICE

(71) Applicant: Michael Pond, Henderson, NV (US)

(72) Inventor: Michael Pond, Henderson, NV (US)

(21) Appl. No.: 14/640,671

(22) Filed: Mar. 6, 2015

Related U.S. Application Data
(60) Provisional application No. 61/950,342, filed on Mar. 10, 2014.

(51) Int. Cl. G02C 3/02; A44B 1/28

(52) U.S. Cl. CPC G02C 3/02; A44B 1/28

(57) ABSTRACT

A hinged engagement and retainer device for securely holding a pair of sunglasses to a cap. The retainment device has a contoured hinged clam shell body configuration with a split resilient memory foam insert that will conform to the sunglass frame temple when closed. A fastener on the hinged body shells selectively secures the retainer device in closed position around the frame. A cap engagement pin extends from one-half of the shell body for insertion through the fabric of the cap and is held in place by a fastener slidably disposed on the engagement pin.

This application claims the benefit of U.S. Provisional Application No. 61/950,342, filed Mar. 10, 2014.

### BACKGROUND OF THE INVENTION

1. Technical Field

This invention relates to eyeglass clips and holders to engage and hold a pair of glasses to a remote surface, specifically sunglasses and caps.

2. Description of Prior Art

Prior art devices of this type have a wide variety of designs for holding eyeglasses; see for example U.S. Pat. Nos. 3,825,110, 6,431,351, 7,979,920 and U.S. Publications 2008/0016602, 2010/0294675 and 2012/0272483.

U.S. Pat. No. 3,825,110 is directed to a plastic case for glasses having a molded hard case with two halves hinged together and secured by resilient latch means into which the eyeglasses are placed and retained there within.

U.S. Pat. No. 6,431,351 claims an eyeglass case with an upper and lower half hinged together with a retaining lock for engagement to the eyeglasses and a pen holder positioned in the case so as to enclose the eyeglasses and the pen completely when closed.

U.S. Pat. No. 7,979,920 is directed to a “head wear with eyeglasses” securing apparatus which includes a cap with a fabric strap having a pair of magnetic attachments to its respective ends so as to selectively engage with each other about a pair of eyeglasses retaining the eyeglasses on the cap to which the strap is secured.

U.S. Publication 2008/0016602 shows a hat having a basket on its side with pockets for holding objects such as sunglasses and the like.

U.S. Publication 2010/0294675 illustrates a memory foam case for eyeglasses and jewelry having a hard hinged shell case with a foam insert.

Finally, U.S. Publication 2012/0272483 on a sunglass retainment clip for caps has a clip defining a material insert slot for wedgeably retaining the temple arm of the eyeglasses. A display device is secured to the clip for promotional and associated marking indicia to be placed thereon.

### SUMMARY OF THE INVENTION

A hinged clip selectively and removably secured to a cap surface having a hinged two-part shell for engaging and retaining an aligned eyeglass temple therebetween when closed. Resilient synthetic foam inserts provide a surface conforming medium about the temple arm holding the eyeglass firmly in place when closed by a latch configuration interengageable on the respective hinge shell case elements.

### DESCRIPTION OF THE DRAWINGS

FIG. 1 is a perspective view of the eyeglass cap clip engaged on a pair of eyeglasses positioned on a cap shown in broken lines.

FIG. 2 is a front elevational view of the eyeglass cap clip.

FIG. 3 is a rear elevational view thereof.

FIG. 4 is an enlarged perspective view thereof.

FIG. 5 is a side elevational view of the eyeglass cap clip in open position.

FIG. 6 is a side elevational view of the invention in closed position engaged on an eyeglass.

### DETAILED DESCRIPTION OF THE INVENTION

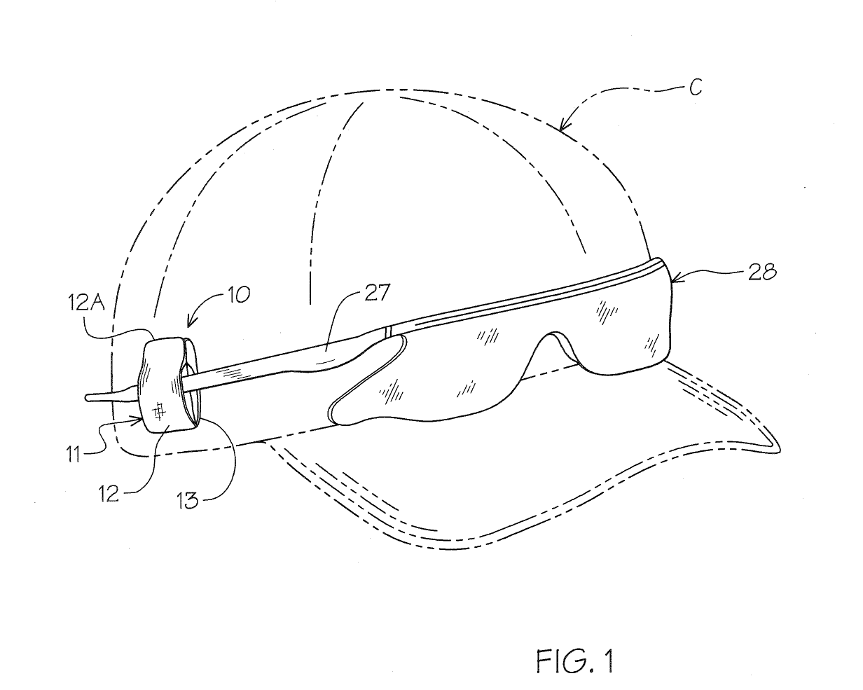

Referring to FIGS. 1-3 and 5 of the drawings, an eyeglass cap clip 10 of the invention can be seen having a hinged “clam shell” shaped body member 11. The body member 11 has a contoured front portion 12 and a base portion 13 with respective top edges 12A and 13A, parallel sides 12B and 13B and respective bottom edges 12C and 13C.

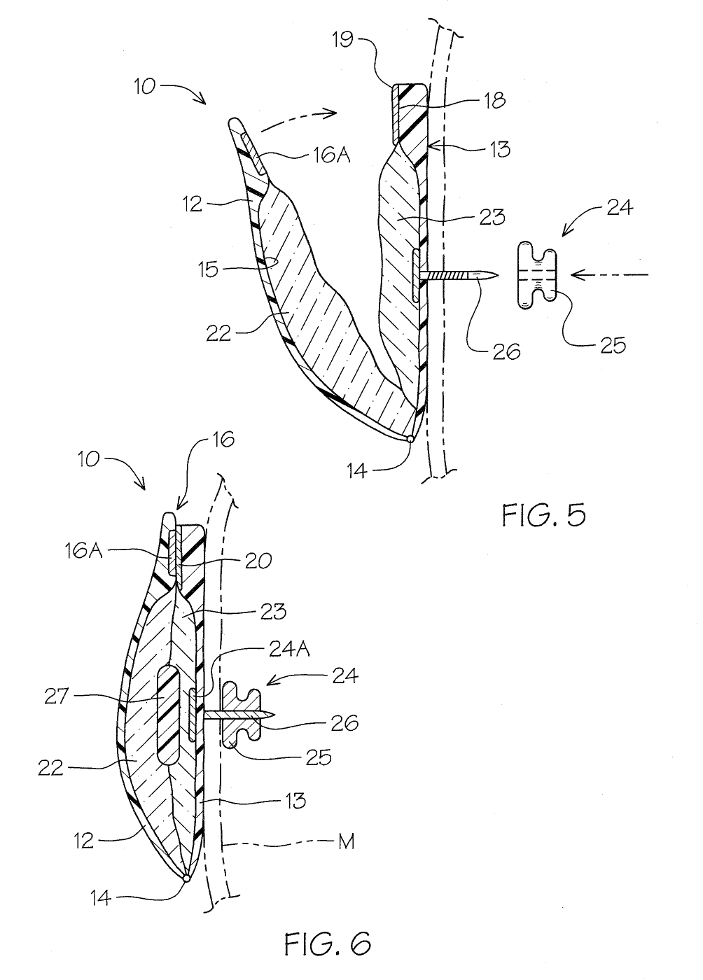

A hinge element 14 is secured to respective bottom edges 12C and 13C joining the contoured front and base portions 12 and 13 together as will be well understood by those skilled in the art. The front contoured shell portion 12 is of a continuous curved configuration with an interior pad receiving area 15 and a latch defining clasp upper edge portion 16 with a magnetic latch element 16A as, best seen in FIG. 5 of the drawings.

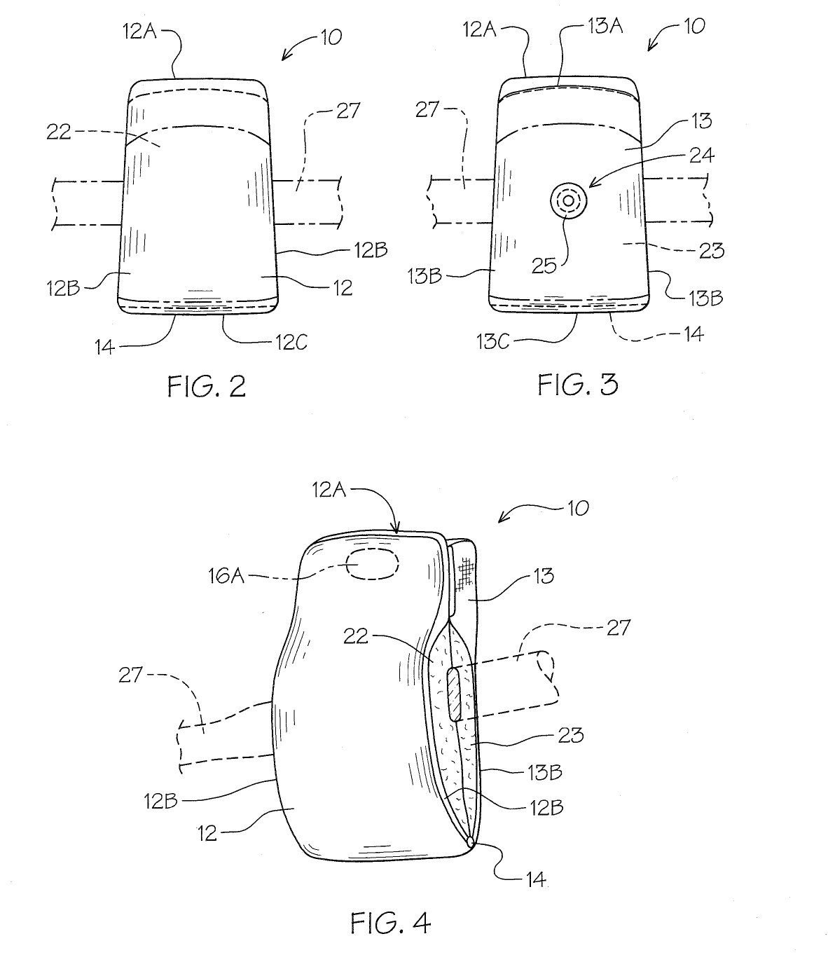

Correspondingly, the oppositely disposed base portion 13 has its own interior pad receiving area 17 with a latch engagement surface 18. In this example, a magnetic latch assembly 19 is illustrated having a magnetic insert 20 for registration with the latch element 16A in the end surface portion 16 of a magnetic attractive material. The base portion 13 is of a registering dimension to that of the front portion 12 and has a latch defined end portion 13A of an increased transverse dimension to support the magnet latch assembly insert 20. The front shell portion 12 extends marginally beyond the corresponding adjacent edge 13A of the base portion 13 so as to afford a tactile engagement by user for opening. Synthetic resin expanded resilient memory foam inserts 22 and 23 are positioned and shaped to conform within and secured to the respective pad receiving areas 15 and 17 by adhesive A, best seen in FIGS. 5 and 6 of the drawings and in broken lines in FIGS. 2 and 3 of the drawings.

A cap engagement and mounting pin assembly 24 extends through and from the surface S of the base portion 13 having pin support base 24A and pin portion 26. A pin retainment engagement fitting button 25 is provided so as to be slidably disposed and retained on the pin 26 once it is inserted through the retainment material M shown in broken lines in FIGS. 5 and 6 of the drawings as will be well known and understood by those skilled in the art.

Referring now to FIGS. 1-4, and 6 of the drawings, the eyeglass cap clip 10 of the invention can be seen closed and engaged on an eyeglass temple 27 of a pair of sunglasses 28, see FIG. 1 of the drawings. The respective synthetic memory foam inserts 22 and 23 are deformed around the temple 27 holding it and the sunglasses 28 securely within on the cap C when not in use. The hereinbefore described pin assembly 24 is used to insert through a cap surface material M as seen in FIGS. 5 and 6 of the drawings and retain the eyeglass cap clip 10 in place thereon before sunglass 28 insertion and retainment.

It will be evident that an alternate latch assembly can be utilized having, for example, a friction enabled retainment closure latch element, not shown, as would be well understood with the art.

It will thus be seen that a new and novel eyeglass cap clip 10 of the invention has been illustrated and described and it will be apparent to those skilled in the art that various changes and modification may be made thereto without departing from the spirit of the invention.

It will also be evident that by utilization of such an eyeglass cap clip 10, a wide variety of eyeglasses can be easily and quickly retained therewithin and positioned on a cap configuration so as to provide ease and mobility as well as accessibility for sunglasses on a various types of headwear configurations, including sport caps and the like.

Therefore I claim:

1. A portable retaining clip for sunglasses comprising,
a pair of contoured shell body members hinged together by a hinge element,
a resilient foam insert in each of said shell halves, a latch means in said respective shell halves holding said shell halves together when closed about an eyeglass temple,
a mounting pin assembly extending from one shell half for registration with a penetrable support surface.

2. The portable retaining clip for sunglasses set forth in claim 1 wherein said resilient foam inserts are secured to oppositely disposed pad receiving areas in said respective shell body members.

3. The portable retaining clip for sunglasses set forth in claim 1 wherein said latch means comprises,
a pair of magnetic inserts in said respective shell body members in oppositely disposed aligned registration relation to one another when in closed position.

4. The portable retaining clip set forth in claim 1 wherein said latch means further comprises,
a shell latch end portion of increased transverse dimension.

5. The portable retaining clip set forth in claim 1 wherein said mounting pin assembly comprises,
a pin portion on a mounting base extending outwardly from one of said shell body members and a pin engagement retainment button selectively engaged and retained on said pin after pin insertion through a support surface.

6. The portable retaining clip set forth in claim 1 wherein said shell body members are of a registering dimension and said resilient foam inserts are adapted to engage one another when said shell body members are closed and latched together.

7. The portable retaining clip set forth in claim 1 wherein said resilient foam inserts are synthetic resin memory foam.

8. The portable retaining clip set forth in claim 2 wherein said resilient foam inserts are secured to said respective pad receiving areas by adhesive.
